(19) United States
(12) Patent Application Publication
(10) Pub. No.: US 2024/0142019 A1
(43) Pub. Date: May 2, 2024

(54) ACTUATING DEVICE, SANITARY INSTALLATION AND CORRESPONDING USE

(71) Applicant: Neoperl GmbH, Müllheim (DE)

(72) Inventor: Adrijan STRMSEK, Maribor (SI)

(73) Assignee: Neoperl GmbH, Müllheim (DE)

(21) Appl. No.: 18/279,238

(22) PCT Filed: Mar. 16, 2022
(86) PCT No.: PCT/EP2022/056871

§ 371 Date: Aug. 29, 2023

(30) Foreign Application Priority Data
Mar. 18, 2021 (DE) 20 2021 101 385.0

(51) Int. Cl. F16K 31/56; E03C 1/04; F16K 11/22

(52) U.S. Cl. CPC F16K 31/56; E03C 1/0408; F16K 11/22

(57) ABSTRACT

In an actuation apparatus (7) which is configured for actuating a valve arrangement (8), there is provision for the actuation elements (9) for a valve (10) each to be arranged at the corners of a convex polygon (11) with three or more corners.

### CROSS-REFERENCE TO RELATED APPLICATIONS

This application is a 371 National Phase of PCT/EP2022/056871, filed Mar. 16, 2022, which claims priority from German Patent Application No. 20 2021 101 385.0, filed Mar. 18, 2021, both of which are incorporated herein by reference as if fully set forth.

### TECHNICAL FIELD

The invention relates to an actuation apparatus for a valve arrangement having at least three actuation elements for a valve of the valve arrangement in each case, wherein the actuation elements can each be moved from an idle position into an actuation position, wherein each actuation element after being moved into the actuation position is fixed by means of a releasable locking apparatus in order to prevent a return into the idle position.

### BACKGROUND

It is known in sanitary installations, for example, shower and/or bath fittings, to provide different water routes which can be switched on and off as required by means of actuation elements, for example, diverters.

DE 20 10 320 A1 discloses a multi-path control unit for the supply lines and discharge lines of flowing media by means of two or more blocking members which can be locked in the end positions, wherein the end positions of one or more blocking members can be locked by the end position of another corresponding blocking member mutually and reciprocally.

U.S. Pat. No. 4,429,711 A discloses a multiple valve block control and locking system, wherein the multiple valve block comprises three valves which are arranged in a valve member, wherein valve shafts with optional grips which can be gripped and rotated are located above the valve member.

CN 201 836 447 A discloses a modified intelligent constant temperature water discharge apparatus which comprises a member having a warm water inlet channel, a cold water inlet channel and a water outlet channel, wherein a constant temperature valve slider component which is arranged between the warm water inlet channel, the cold water inlet channel and the water outlet channel is arranged in the member, wherein a central control unit and an electric motor are further arranged in the member.

Additional valve arrangements are known from GB 11676 A A.D. 1910 and WO 2005/033565 A1.

### SUMMARY

An object of the invention is to technically enable new possible configurations for fittings.

In order to achieve the above-mentioned objective, an actuation apparatus with one or more of the features of disclosed herein is provided. In particular, consequently, in order to achieve the above-mentioned objective, in an actuation apparatus of the type described in the introduction it is proposed according to the invention that the at least three actuation elements describe corners of a polygon, that the actuation elements can be manually operated and that the actuation directions of the actuation elements are orientated parallel with each other. Consequently, a deviation from the previously conventional linear arrangement is possible, which opens up additional configuration freedom for the external configuration of a fitting. A polygon may, for example, be characterised as a geometric figure comprising at least three locations which are connected by means of (linear) paths.

The non-linear arrangement of the actuation elements has the additional advantage that the force relationships can be configured in a more favourable manner since locking elements of the locking apparatus can be mutually supported. A support with respect to a housing can consequently be dispensed with.

The polygon may, for example, be convex. Attractive configuration possibilities are thereby produced. Shapes which are easy to clean can also be produced. A convex polygon may, for example, be characterised as a polygon, in which all the internal angles of the corners are less than 180°.

It is particularly aesthetically attractive when the polygon is regular, that is to say, for example, has the same side lengths and/or the same internal angles.

This has the additional advantage that the locking apparatus can be constructed symmetrically with respect to the actuation elements. This simplifies a structural construction and/or can assist in reducing a large number of components.

In an advantageous embodiment, there may be provision for the locking apparatus to have at least one locking element which can be moved from an idle position into a release position counter to a restoring force. The idle position may in this instance be a locking position. Consequently, an independent fixing and/or release of the locking apparatus can be configured.

In an advantageous embodiment, there may be provision for the locking apparatus to be configured for positive-locking fixing of the actuation element. Consequently, a mechanical retention of the actuation element can be achieved. An additional energy supply for developing a retention force can be dispensed with.

In an advantageous embodiment, there may be provision for there to be formed on each actuation element an inclined approach member by means of which an associated locking element of the locking apparatus can be moved. Consequently, the associated locking element can be moved by means of an actuation movement of the actuation element, that is to say, a movement into the actuation position. Independent fixing and/or release of the locking apparatus can consequently be achieved.

In an advantageous embodiment, there may be provision for there to be formed on each actuation element a retention projection, behind which an associated locking element engages for fixing. Consequently, a simple means is described as to how the actuation elements may be able to be fixed in the actuation position.

The retention projection may, for example, be a part of a retention groove which may, for example, be constructed to extend around the actuation element.

The retention projection may, for example, engage in a corresponding hole in the at least one locking element. The hole may in this instance be adapted to a size of the actuation element, for example, measured at a location of the engagement in the hole. Consequently, it may be possible for a position or deflection of the locking element to be able to be predetermined by the actuation element which penetrates into the hole.

In an advantageous embodiment, there may be provision for each actuation element to control a pilot valve by means of which a main valve of the associated valve can be actuated by means of an operating pressure applied to the valve. Consequently, an advantageous use is described in which the actuation elements can be actuated with little actuation force. Consequently, a mechanical loading of the actuation apparatus can be reduced.

In an advantageous embodiment, there may be provision for there to be associated with each actuation element a restoring element, by means of which it can be moved into the idle position thereof. Consequently, an independent return of the actuation element, into the idle position thereof can be achieved, particularly when the locking apparatus is released.

In an advantageous embodiment, there may be provision for the actuation elements to be guided in a guiding element. Consequently, a defined actuation movement can be carried out.

In this instance, there may be provision for a restoring element, by means of which at least one actuation element can be moved into the idle position thereof, for example, the restoring element already mentioned, to be supported on the guiding element. Consequently, a compact construction with few individual components is enabled.

In an advantageous embodiment, there may be provision for the locking apparatus to have a locking element which can be pivoted about a location within the polygon, in particular counter to a, for example, the already mentioned, restoring force. This enables a locking element which can fix all the actuation elements to be used in a simple manner.

The location within the polygon may, for example, in particular with a regular polygon, be a centre of the polygon. Consequently, a particularly simple geometric shape of the locking element can be achieved.

In an advantageous embodiment, there may be provision for a fixing of an actuation element to be able to be cancelled by actuating another actuation element. Consequently, additional release elements, by means of which a fixing can be cancelled, can be dispensed with. It is further advantageous for a diverter, by means of which a water route can be switched off when an additional water route is switched on, to be able to be formed in a simple manner.

This may, for example, be achieved by a locking element which can be moved as a whole and/or which is integral being provided for all the actuation elements. Alternatively or additionally, this can be achieved by the locking element being able to be displaced in the same manner by means of all the actuation elements.

In an advantageous embodiment, there may be provision for the locking apparatus to have at least two separate locking elements which can each be actuated independently of each other. Consequently, the actuation elements can be fixed independently of each other by means of respective independent actuation of the associated locking element. It may consequently become possible for two valves to be able to be opened simultaneously.

In an advantageous embodiment, there may be provision for a restoring element to be formed for each locking element. Consequently, an individual engagement in a, for example, the already mentioned, locking position is enabled.

A variant which can be produced in a particularly simple manner may in this instance make provision for the restoring element to be connected integrally to the locking element.

In an advantageous embodiment, there may be provision for the locking elements to be movably arranged radially with respect to a location within the polygon. Consequently, a space-saving arrangement of the locking elements within or primarily within the polygon is possible. Complications as a result of mutual interactions of the locking elements can be prevented.

The location within the polygon may, for example, in particular with a regular polygon, be a centre of the polygon. Consequently, a particularly simple geometric shape of the locking element can be achieved.

In an advantageous embodiment, there may be provision for a release element for deactivating the locking apparatus to be formed. Consequently, a release of the locking apparatus is also possible when all the actuation elements are fixed in their actuation position.

It is advantageous, in particular with radially movable locking elements, for the release element to be arranged at the centre of the polygon. Consequently, a common release of all the locking elements is possible.

A preferred application of the invention provides a sanitary installation, in particular a shower and/or bath fitting, having an actuation apparatus according to the invention, in particular as described above and/or according to one of the claims which is directed towards an actuation apparatus.

Correspondingly, there is consequently proposed as a preferred application of the invention a use of an actuation apparatus according to the invention, in particular as described above and/or according to one of the claims which is directed towards an actuation apparatus, in a sanitary installation, in particular a shower and/or bath fitting.

### BRIEF DESCRIPTION OF THE DRAWINGS

The invention will now be described in greater detail with reference to embodiments, but it is not limited to the embodiments. Other embodiments will be appreciated by combining the features of individual or a plurality of claims with each other and/or with individual or a plurality of features of the embodiments.

In the drawings:

FIG. 1 shows an actuation apparatus according to the invention in a three-dimensional oblique view from above,

FIG. 2 shows the actuation apparatus from FIG. 1 in a partially cut-away oblique view,

FIG. 3 shows an exploded illustration of the actuation apparatus from FIG. 1,

FIG. 4 shows another actuation apparatus according to the invention in a three-dimensional oblique view from above,

FIG. 5 shows the actuation apparatus from FIG. 4 with the cover removed,

FIG. 6 shows the actuation apparatus from FIG. 4 in a partially cut-away oblique view,

FIG. 7 shows a locking element of the actuation apparatus from FIG. 4 in the locking position,

FIG. 8 shows a locking element of the actuation apparatus from FIG. 4 in the release position,

FIG. 9 shows an exploded illustration of the actuation apparatus from FIG. 4,

FIG. 10 shows the movement sequence of an actuation element from the idle position (top) into the actuation position (bottom) in the actuation apparatus from FIG. 4,

FIG. 11 shows the movement sequence of a release element when the locking apparatus is released and the corresponding movement of the actuation element from the actuation position (top) into the idle position (bottom) in the actuation apparatus from FIG. 4, and

FIG. 12 shows a sanitary installation according to the prior art.

### DETAILED DESCRIPTION

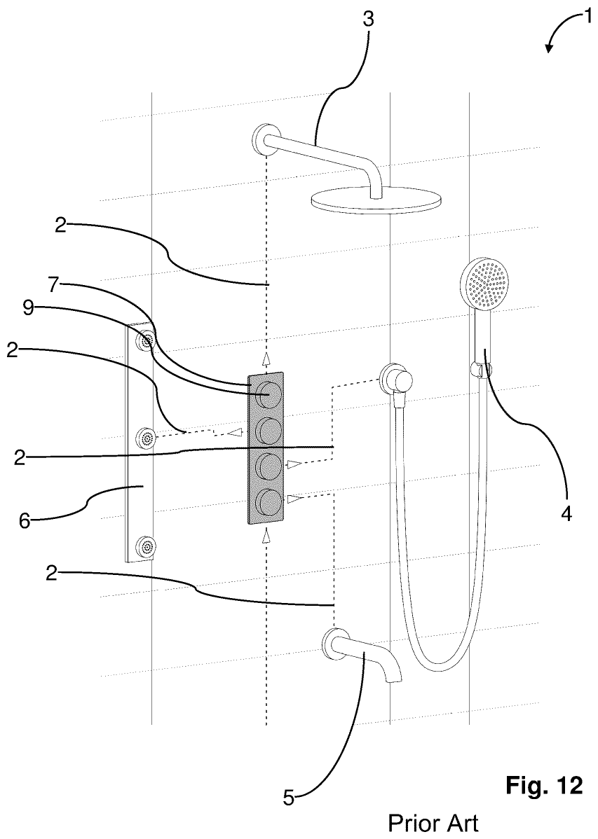

FIG. 12 shows a sanitary installation which is generally designated 1 according to the prior art. The sanitary installation forms water routes 2 which are guided here by way of example to a shower head 3, a hand shower 4, a bath outlet 5 and a massage unit 6. In other embodiments, other numbers and/or types of water outlets may be formed.

An actuation apparatus 7 serves to switch the individual water routes 2 on and off in order to direct the water outflow selectively via individual or a plurality of water outlets. The actuation elements 9 are arranged in a linear manner.

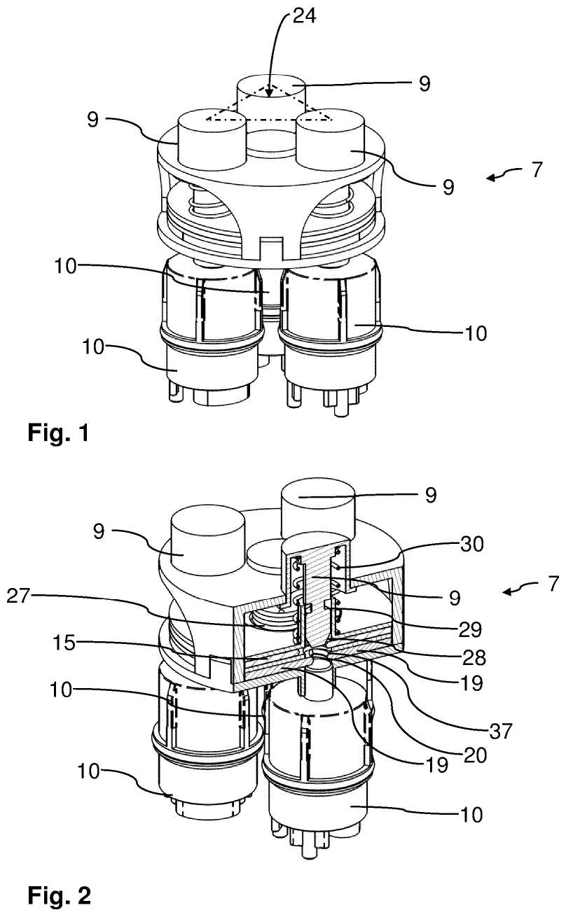

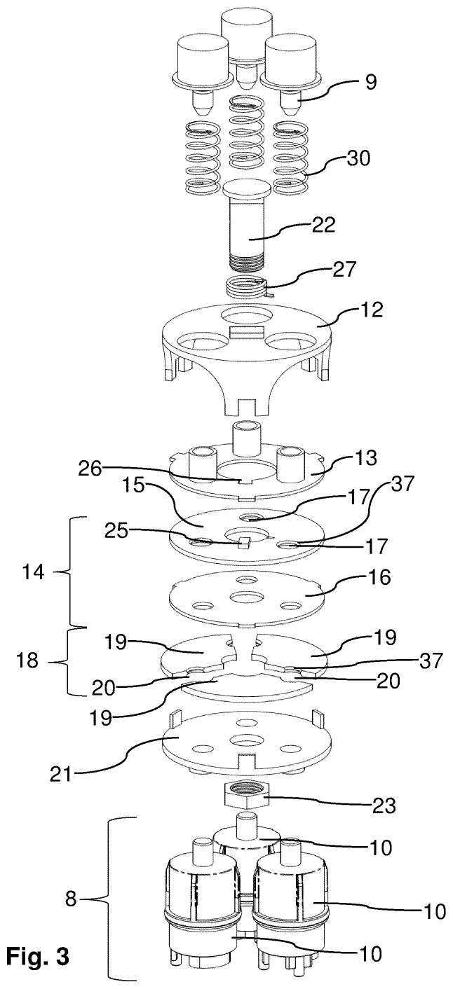

FIGS. 1 to 3 show an actuation apparatus 7 according to the invention for use in the sanitary installation 1 in place of the actuation device 7 which is shown at that location.

The actuation apparatus 7 serves to actuate a valve arrangement 8 which is arranged thereunder and/or which forms a unit therewith.

The actuation apparatus 7 has a plurality of actuation elements 9 which can be adjusted between an idle position and an actuation position.

The valve arrangement 8 accordingly has a plurality of valves 10 which each switch a water route 2.

FIGS. 1 to 3 show by way of example the case in which three water routes 2 can be switched. In other embodiments, more than three, for example four, actuation elements 9 and valves 10 are provided in order to switch a desired number of water routes 2.

In FIGS. 1 to 3, the three actuation elements 9 describe as a result of their arrangement the corners of a polygon 11 in the form of an equilateral triangle.

In other embodiments, the actuation elements 9 describe as a result of their arrangement the corners of an n-sided polygon, n>3, where n is equal to the number of actuation elements 9.

The actuation apparatus 7 in FIGS. 1 to 3 has a cover 12 which retains the actuation elements 9.

The actuation movement of the actuation elements 9 is guided by a guiding element 13.

The locking apparatus 14 comprises a locking element 15 and a corresponding counter-element 16.

The locking element 15 and the counter-element 16 in each case have holes 17, the size of which is adapted to the actuation elements 9 which engage through the holes 17. Consequently, a position of the locking element 15 is determined when the actuation elements 9 engage in the holes 17.

The locking element 15 can be rotated counter to the counter-element.

A blocking element 18 comprising three segments 19 (or the same number of segments as there are actuation elements) is arranged below the locking apparatus 14.

The segments 19 can be moved in a pivot movement.

A hole 20 is formed between adjacent segments 19 in each case. If the adjacent segments of a hole 20 are spaced apart from each other to the maximum extent, the hole 20 is larger than the actuation element 9 which extends through it. The actuation element 9 can then be introduced into the hole 20.

If the adjacent segments of a hole 20 are spaced apart from each other to the minimum extent, the hole 20 is smaller than the actuation element 9 which extends through it. The actuation element 9 then cannot be introduced into the hole 20. It can be seen that the segments 19 are mutually supported as a result of the non-linear arrangement.

In other embodiments, a segment 19 is omitted. The remaining two segments 19 also prevent two actuation elements 9 from being able to be actuated at the same time since each segment 19 blocks the simultaneous actuation of the adjacent actuation elements 9 and the two segments 19 together the simultaneous actuation of the external actuation elements 9.

The actuation apparatus 7 finally has a base plate 21 which retains the disc-like guiding element 13, the disc-like locking element 15, the disc-like counter-element 16 and the disc-like segments 19 in a stack arrangement.

A securing means 22 and a counter-securing means 23 hold the stack arrangement together.

The valves 10 are secured on the base plate 21. If an actuation element 9 is pressed from the idle position thereof according to FIG. 2 so far down that it engages through the holes 17 and 20, the associated valve 10 is actuated.

The locking element 15 is rotatably retained about a location inside the polygon 11, in this instance the centre 24.

A play limitation 25 which cooperates with a recess 26 on the guiding element 13 (or on another rotatably secure component) limits the available pivot angle.

A restoring element 27 defines an idle position of the locking element 15.

The actuation elements 9 have inclined approach members 28 by means of which the locking element 15 during an actuation movement is pivoted out of an idle position. The inclined approach members 28 cooperate in this instance with counter-inclinations 37 on the locking element 15.

If the actuation element 9 is actuated further, the locking element 15 engages behind a retention projection 29, whereby a return movement of the actuation element 9 is blocked.

If another actuation element 9 is actuated, the locking element 15 is deflected again into the release position thereof. This leads to the actuation element 9 which has been actuated first no longer being fixed, but instead being moved by a restoring element 30 into the idle position thereof. The restoring element 30 is supported to this end on the guiding element 13.

If an actuation element 9 is moved into the actuation position thereof, the adjacent segments 9 are displaced. The remaining holes 20 of the blocking element 18 are thereby reduced in size so that the associated actuation elements 9 no longer fit through. It is consequently not possible to move two actuation elements into the actuation positions thereof at the same time.

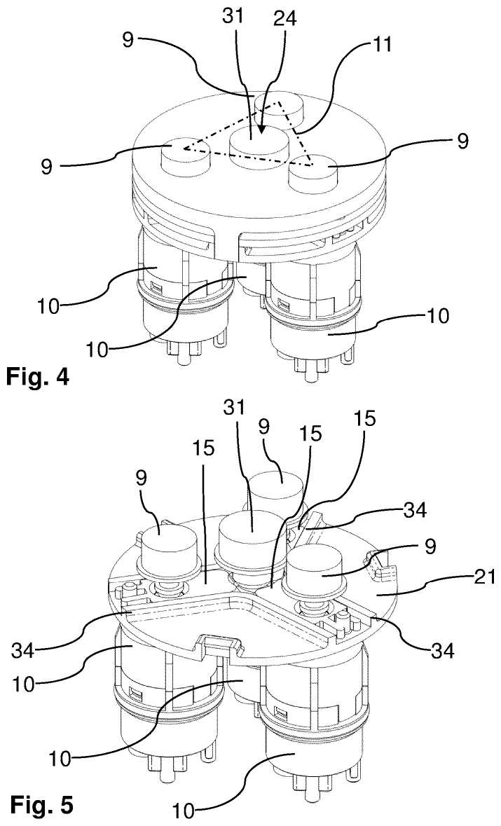

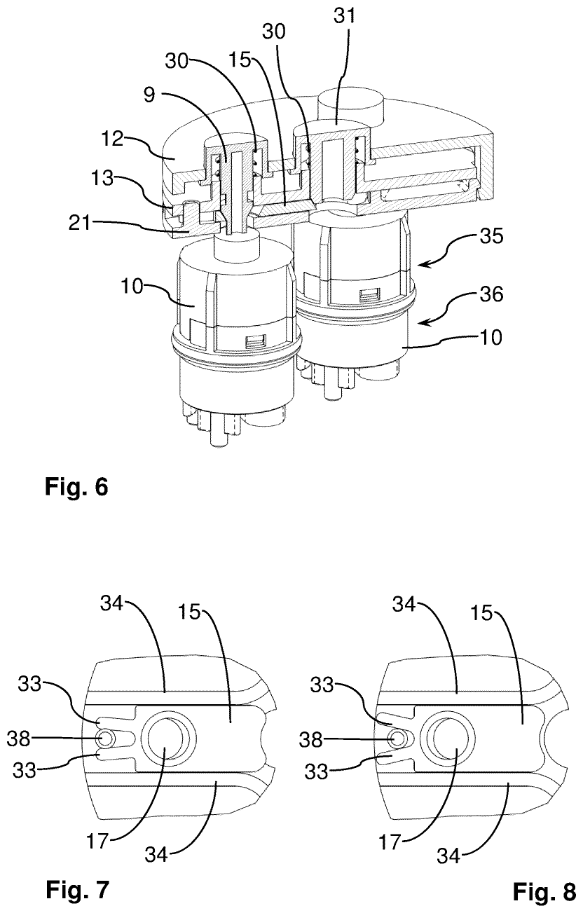

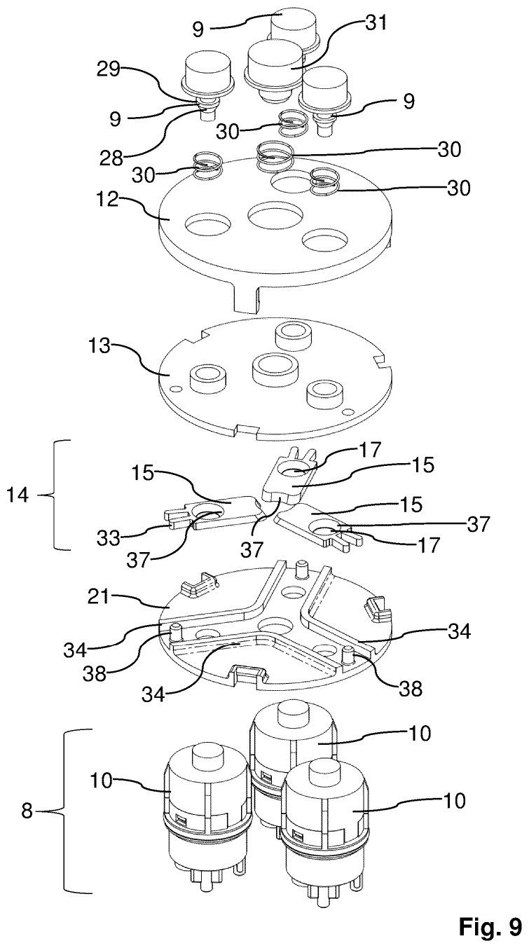

FIGS. 4 to 11 show another embodiment according to the invention. Components and functional units which are functionally and/or structurally equivalent or identical to the previous embodiments are given the same reference numerals and are not described again separately. The embodiments relating to FIGS. 1 to 3 therefore apply accordingly to FIGS. 4 to 11.

The embodiment differs from the previous embodiment in that a plurality of separate locking elements 15 which are furthermore not arranged pivotably but instead radially with respect to the centre 24 (independently of each other) are constructed.

In other embodiments, the locking elements 15 can be displaced along other paths.

In other embodiments, one of the locking elements 15 is omitted. The associated actuation element 9 consequently becomes a push-button, for example, in order to release the other actuation elements from the locking action.

By comparing FIG. 7 and FIG. 8, it becomes clear that the restoring elements 27 which are associated with each locking element 15 are formed integrally and ensure a return into an idle position (FIG. 7). In this instance, the restoring elements 27 cooperate with matching projections 38.

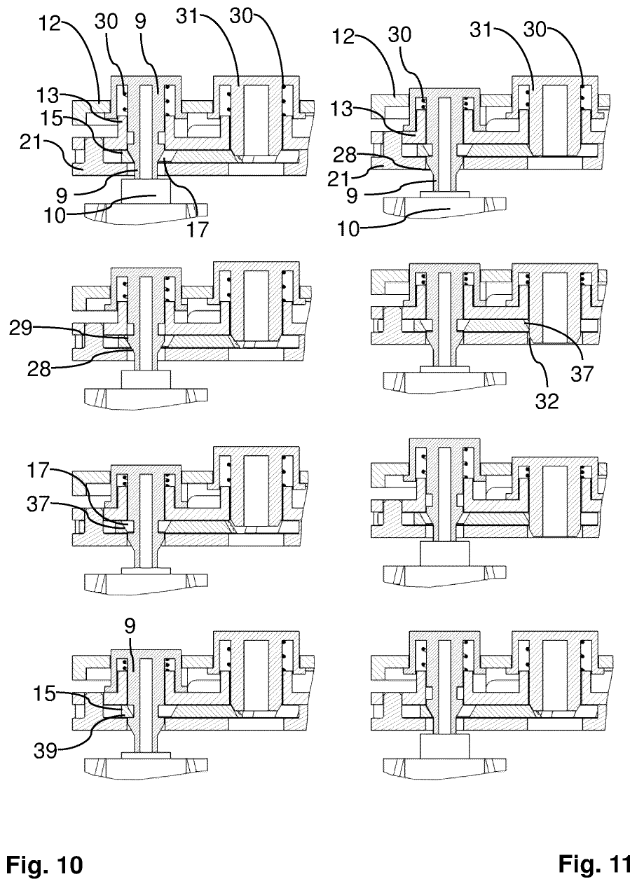

FIG. 10 shows the movement sequence during an actuation movement from top to bottom.

The inclined approach member 28 on the actuation element 9 displaces the locking element 15 again (second image from the top) until the locking element 15 can engage behind the retention projection 29 (third image from the top).

The restoring element 27 now moves the locking element 15 into the idle position thereof (fourth image from the top) so that the actuation element 9 is fixed in the actuation position thereof.

The remaining actuation elements 9 can now be moved into their actuation position in the same manner.

Should all the actuated actuation elements 9 be returned into their respective idle position, the release element 31 must be actuated. This is shown in FIG. 11 from top to bottom.

It can be seen that the release element 31 also has an inclined approach member 32 by means of which all the locking elements 15 can be radially displaced (first image from the top) until the associated actuation elements 9 are free again (second image from the top). The actuation elements 9 can now return to the idle position again (third image from the top).

The inclined approach member 32 cooperate in this instance with corresponding counter-inclinations 37 on the locking elements 15.

A restoring element 33 moves the release element 31 into the idle position thereof again.

If two actuation elements 9 are intended to be prevented from being able to be pressed at the same time, a blocking element 18 having pivotable segments 19 may be arranged as in FIGS. 1 to 3.

The locking elements 15 are guided on the base plate 21 or a counter-element 16 (cf. FIGS. 1 to 3) with guiding means 34.

The valves 10 of the embodiments may in a manner known per se have a pilot valve 35 and a main valve 36. In this instance, with the pilot valve 35 a pressure chamber can be filled and emptied again from an operating pressure applied to the valve 10. An internal pressure in the pressure chamber determines in this instance a switching position of the main valve 36. Consequently, an actuation force of the valve 10 may be smaller than a force for carrying out the switching movement of the main valve 36. The mechanics of the actuation apparatus 7 can consequently be configured for these smaller forces.

In an actuation apparatus 7 which is configured to actuate a valve arrangement 8, there is consequently provision for arranging the actuation elements 9 for a valve 10 each at the corners of a convex polygon 11 with three or more corners.

### LIST OF REFERENCE NUMERALS

1 Sanitary installation
2 Water route
3 Shower head
4 Hand shower
5 Bath outlet
6 Massage unit
7 Actuation apparatus
8 Valve arrangement
9 Actuation element
10 Valve
11 Polygon
12 Cover
13 Guiding element
14 Locking apparatus
15 Locking element
16 Counter-element
17 Hole in 15
18 Blocking element
19 Segment
20 Hole in 18/19
21 Base plate
22 Securing means
23 Counter-securing means
24 Centre
25 Play limitation
28 Recess
27 Restoring element (for restoring 15)
28 Inclined approach member on 9
29 Retention projection
30 Restoring element
31 Release element
32 Inclined approach member on 31
33 Restoring element for 15
34 Guiding means
35 Pilot valve
36 Main valve
37 Counter-inclination
38 Projection
39 Locking position

1. An actuation apparatus (7) for sanitary use, the actuation apparatus comprising:
a valve arrangement (8) having a valve (10);
at least three actuation elements (9) for the valve (10) of the valve arrangement (8), the actuation elements (9) are each movable from an idle position into an actuation position;
a releasable locking apparatus (14) by which each of the actuation elements (9) after being moved into the actuation position is fixed in order to prevent a return into the idle position;
the at least three actuation elements (9) describe corners of a polygon (11);
the actuation elements (9) are manually operable; and
actuation directions of the actuation elements (9) are orientated parallel with one another.

2. An actuation apparatus (7) according to claim 1, wherein the locking apparatus (14) has at least one locking element (15) which is movable from an idle position into a release position counter to a restoring force.

3. An actuation apparatus (7) according to claim 2, wherein the locking apparatus (14) is configured for positive-locking fixing of the actuation element (9).

4. Actuation apparatus (7) according to claim 3, wherein on each of the actuation elements (9) an inclined approach member (28) is formed by which the associated locking element (15) of the locking apparatus (14) is movable.

5. The actuation apparatus (7) according to claim 2, wherein on each of the actuation elements (9) a retention projection (29) is formed behind which the associated locking element (15) engages for fixing.

6. The actuation apparatus (7) according to claim 5, wherein the retention projection (29) on each of the actuation elements (9) engages in a corresponding hole (17) in the at least one locking element (15).

7. The actuation apparatus (7) according to claim 1, wherein each of the actuation elements (9) controls a pilot valve (35) by which a main valve (36) of the associated valve (10) is actuatable by an operating pressure applied to the valve (10).

8. The actuation apparatus (7) according to claim 1, wherein a restoring element (30) is associated with each of the actuation elements (9) by which the actuation element is movable into the idle position thereof.

9. The actuation apparatus (7) according to claim 8, wherein the actuation elements (9) are guided in a guiding element (13).

10. The actuation apparatus (7) according to claim 1, wherein the locking apparatus (14) has a locking element (15) which is pivotable about a location within the polygon (11).

11. The actuation apparatus (7) according to claim 1, wherein a fixing of one of the actuation elements (9) is cancellable by actuating another of the actuation elements (9).

12. The actuation apparatus (7) according to claim 1, wherein the locking apparatus (14) has at least two separate locking elements (15) which are each actuatable independently of one another.

13. The actuation apparatus (7) according to claim 12, further comprising a restoring element (27) is formed for each of the locking elements (15).

14. The actuation apparatus (7) according to claim 12 the locking elements (15) are movably arranged radially with respect to a location within the polygon (11).

15. The actuation apparatus (7) according to claim 1, further comprising a release element (31) for deactivating the locking apparatus (14).

16. A sanitary installation (1), comprising the actuation apparatus (7) according to claim 1.

17. A shower or bath fitting comprising the actuation apparatus (7) according to claim 1.

18. The actuation apparatus (7) according to claim 4, wherein the inclined approach members (28) cooperate with counter-inclinations (37) on the locking element (15).

19. The actuation apparatus (7) according to claim 6, wherein the hole (17) is adapted to a size of the actuation element (9) measured at a location of engagement in the hole (17).

20. The actuation apparatus (7) according to claim 9, wherein the restoring element (30), by which at least one actuation element (9) is movable into the idle position thereof is supported on the guiding element (13).
